(19) United States
(12) Patent Application Publication
(10) Pub. No.: US 2016/0150103 A1
(43) Pub. Date: May 26, 2016

(54) PRINTING SERVER, PRINTING MANAGEMENT METHOD, AND DATA STORAGE PRINTING SYSTEM

(71) Applicant: SEIKO EPSON CORPORATION, Tokyo (JP)

(72) Inventors: Masayuki KOBAYASHI, Fujimi-machi (JP); Norihiko YAMADA, Nagano (JP); Toshiaki OKAYAMA, Ikeda-machi (JP)

(21) Appl. No.: 14/856,892

(22) Filed: Sep. 17, 2015

(30) Foreign Application Priority Data
Nov. 21, 2014 (JP) 2014-236453

(51) Int. Cl. H04N 1/00; H04N 1/32; G06F 3/12

(52) U.S. Cl. CPC H04N 1/00212; G06F 3/1204; G06F 3/1267; H04N 1/00244; H04N 1/32374

(57) ABSTRACT

A printing server includes a scan data receiving portion that receives, via the Internet, a set of scan data resulting from canning of a document; a storage server communication portion that transmits the set of scan data to a storage server that stores data therein in a state in which the data is ready for being downloaded by an external terminal; a printing data generation portion that, on the basis of the set of scan data, generates a set of printing data in accordance with which a printer performs printing; and a printer communication portion that transmits the set of printing data to a printer corresponding to a designated e-mail address.

### BACKGROUND

1. Technical Field

The present inventions relates to a printing server, a printing management method, and a data storage printing system.

2. Related Art

There has been known a technology for obtaining sets of digital data by scanning documents and storing each of the obtained sets of digital data into one of online storages through the Internet (refer to, for example, JP-A-2014-135631).

In JP-A-2014-135631, there is disclosed a system in which an image formation apparatus is communicably connected to each of a plurality of external storage devices consisting of a storage server, a cloud-computing storage, and the like, via a network. The image formation apparatus is configured to generate a plurality of sets of image data by reading in images on documents, and store once each of the generated sets of image data into one of the plurality of external storage devices consisting of the storage server, the cloud-computing storage, and the like. Further, the image formation apparatus is configured to, when a process of printing, editing, or the like is performed, receive sets of image data that are among the stored sets of image data and that are targets of the process, from external storage devices that constitute the plurality of external storage devices and that are storage destinations of the sets of image data to be received.

It is inferred that, when a certain user causes a scanner to scan a document, there exists another user who desires to obtain a copy of the document as promptly as possible. Moreover, it is inferred that the another user is located at a place different from a place where the user who has caused a scanner to scan a document is located, and desires to promptly utilize a copy of the document in a work of the another user. It is hard to say, however, that, heretofore, the aforementioned process of merely storing each of sets of image data obtained by scanning documents into one of online storages has sufficiently satisfied such a user's desire.

### SUMMARY

An advantage of some aspects of the invention is that a printing server, a printing management method, and a data storage printing system are provided, each of which enables improvement of convenience for users who desire to utilize sets of image data resulting from scanning of documents.

According to a first aspect of the invention, a printing server includes a scan data receiving portion that receives, via the Internet, a set of scan data resulting from scanning of a document; a storage server communication portion that transmits the set of scan data to a storage server that stores data therein in a state in which the data is ready for being downloaded by an external terminal; a printing data generation portion that, on the basis of the set of scan data, generates a set of printing data in accordance with which a printer performs printing; and a printer communication portion that transmits the set of printing data to a printer corresponding to a designated e-mail address.

According to this configuration, both of the storage of a set of scan data into the storage server and printing that is based on the set of scan data and that is performed by the printer corresponding to a designated e-mail are executed nearly simultaneously. Thus, it is possible to satisfy the aforementioned user's desire to promptly obtain a copy of a document that has just been subjected to scanning.

According to a second aspect of the invention, in the above aspect of the invention, the storage server communication portion may be configured to append a piece of history information relating to printing by the printer corresponding to the designated e-mail address, and transmit the set of scan data, to which the piece of history information is appended, to the storage server.

According to this configuration, when a user downloads a set of scan data stored in the storage server by using an external terminal to browse the set of scan data, the user is able to confirm at least one piece of history information relating to printing based on the set of scan data.

According to a third aspect of the invention, in the above aspect of the invention, the printer communication portion may be configured to receive a completion notification for notifying a completion of the printing in accordance with the set of printing data, from the printer corresponding to the designated e-mail address, and the storage server communication portion may be configured to, upon reception of the completion notification, append a piece of information relating to the completion of the printing to the set of scan data as the piece of history information.

According to this configuration, when a user downloads a set of scan data stored in the storage server by using an external terminal to browse the set of scan data, the user is able to confirm whether or not printing based on the set of scan data is already completed.

According to a fourth aspect of the invention, in the above aspect of the invention, the printing data generation portion may be configured to generate the set of printing data such that the set of printing data includes a piece of access information that is provided in a form of an image and that is for use in an access through the Internet to a service provided by the storage server.

According to this configuration, a piece of access information is included in a result of printing that is based on a set of printing data and that is performed by the printer corresponding to a designated e-mail. Thus, a user is able to easily access a service that is provided over the Internet by the storage server, by referring to the piece of access information included in the result of the printing.

According to a fifth aspect of the invention, in the above aspect of the invention, the printing data generation portion may be configured to generate the set of printing data such that an image corresponding to the set of scan data and an image corresponding to the piece of access information are each drawn within a corresponding one of mutually different pages.

According to this configuration, in a result of printing by the printer corresponding to a designated e-mail, a copy of a document having been subjected to scanning and the piece of access information are each obtained on a corresponding one of mutually different pages.

According to a sixth aspect of the invention, in the above aspect of the invention, the printing server may be configured to further include an image processing portion that generates a set of edited scan data corresponding to a plurality of sets of scan data each of which results from scanning of a corresponding one of a plurality of documents and which are disposed within a common page. Further, the storage server communication portion may be configured to transmit the set of edited scan data to the storage server, and the printing data generation portion may be configured to generate the set of printing data on the basis of the set of edited scan data.

According to this configuration, since a printing output in which images corresponding to a plurality of documents are collectively disposed within a common page is obtained as a result of printing that is based on the generated set of printing data and that is performed by the printer corresponding to a designated e-mail address, the number of sheets of paper for use in the printing is reduced and this reduction leads to cost savings.

The technical thought of the invention can be realized in various categories other than the category of the printing server. For example, the invention may be realized in further three categories: a first one being a category of a method including processes performed by individual portions of the printing server (i.e., a printing management method); a second one being a category of a computer program that causes a computer to execute the method; and a third one being a category of a storage medium that stores the program therein and that is readable by a computer.

Moreover, a data storage printing system is also in accordance with an aspect of the invention, and this data storage printing system includes a printing server that transmits a set of printing data to a printer corresponding to a designated e-mail address to cause the printer to perform printing in accordance with the set of printing data; and a storage server that stores data therein in a state in which the data is ready for being downloaded by an external terminal. Further, the printing server includes a scan data receiving portion that receives, via the Internet, a set of scan data resulting from scanning of a document, a storage server communication portion that transmits the set of scan data to the storage server, a printing data generation portion that, on the basis of the set of scan data, generates the set of printing data in accordance with which the printer corresponding to the designated e-mail address is caused to perform printing, and a printer communication portion that transmits the set of printing data to the printer corresponding to the designated e-mail address.

### BRIEF DESCRIPTION OF THE DRAWINGS

The invention will be described with reference to the accompanying drawings, wherein like numbers reference like elements.

FIG. 1 is a schematic block diagram illustrating a configuration of a system according to a first embodiment of the invention.

FIG. 2 is a flowchart illustrating an example of processing performed by a printing server according to a first embodiment of the invention.

FIG. 3 is a diagram illustrating an example of images corresponding to a set of printing data according to a second embodiment of the invention.

FIG. 4 is a diagram illustrating an example of images corresponding to a set of printing data according to a third embodiment of the invention.

### DESCRIPTION OF EXEMPLARY EMBODIMENTS

Hereinafter, embodiments according to the invention will be described with reference to the drawings.

### 1. First Embodiment

1.1 Outline of System

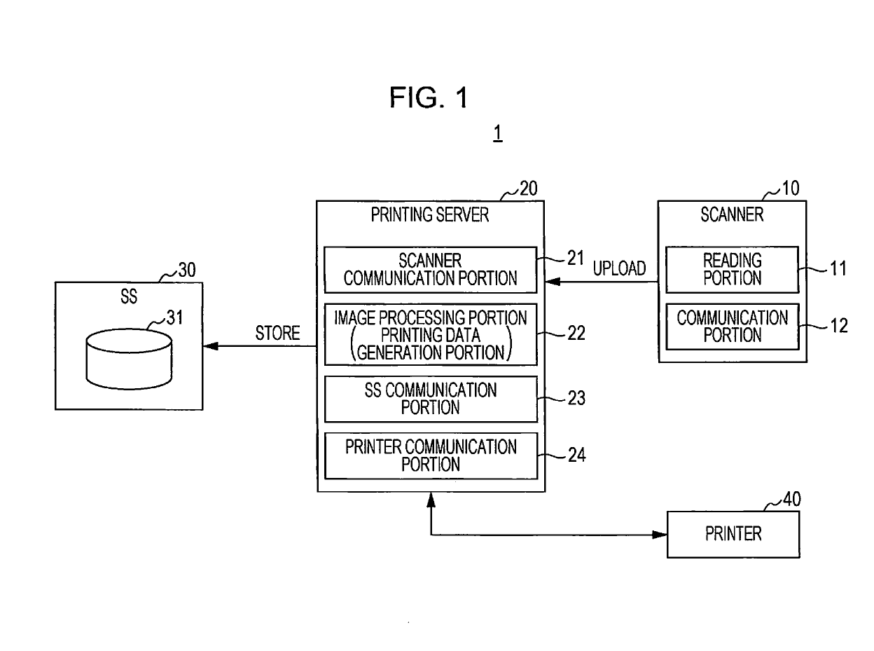

Referring to FIG. 1, which is a schematic brock diagram illustrating a configuration of a system 1 according to a first embodiment of the invention, the system 1 includes a scanner 10, a printing server 20, a storage server (SS) 30, and a printer 40. Each of these constituent components 10, 20, 30, and 40 of the system 1 allows an invention to come into existence, and a combination (a system) of any two or more of these constituent components 10, 20, 30, and 40 also allows an invention to come into existence. Communication between the constituent component 20 and each of the constituent components 10, 30, and 40 is communication utilizing, for example, the Internet, and is realized in accordance with protocols (a TCP/IP protocol, an HTTP protocol, and the like) that are authorized by standardization groups, such as Internet Engineering Task Force (IETF).

The scanner 10 is a device or a system that scans an image on a document that is optionally prepared by a user; generates a set of scan data corresponding to the image; and uploads the generated set of scan data to a predetermined upload destination (the printing server 20) via the Internet. Thus, the scanner 10 includes at least a reading portion 11 that generates a set of image data (scan data) by optically reading in an image on a document; and a communication portion 12 that transmits the set of scan data having been generated by the reading portion 11 to the predetermined upload destination via the Internet. The scanner 10 may be a so-called multi-function machine provided with a plurality of functions including, in addition to the above-described functions as the scanner, a printing function, a facsimile function, and/or the like.

Further, the scanner 10 may be a system including the reading portion 11 and the communication portion 12 that are each provided in a corresponding one of separate devices. The scanner 10 is conceptually constituted by two portions; one being a scanner that mainly functions as the reading portion 11; the other one being a terminal that mainly functions as the communication portion 12. In addition, a term “terminal” used in this embodiment corresponds to all types of terminals each of which has the function of establishing a connection to the Internet, and which include a personal computer (PC), a mobile phone, a smart phone, a tablet terminal, and the like. In the above case, the scanner (the reading portion 11) transmits a generated set of scan data to the terminal (the communication portion 12) via, for example, a local area network (LAN) that is established so as to include the terminal (the communication portion 12) and the scanner (the reading portion 11), or a near field communication (NFC) that is established between the terminal (the communication portion 12) and the scanner (the reading portion 11). The communication portion 12 transmits the set of scan data having been received from the reading portion 11 to the upload destination via the Internet.

The printing server 20 is an example of a server that is required in the realization of an e-mail printing system. This e-mail printing system is a computing system that enables a printer to perform printing of a certain content by allocating an e-mail address (hereinafter, referred to as a printer mail address) to the printer in advance and transmitting an e-mail to the printer. That is, the printing server 20 causes a printer corresponding to a designated printer mail address (for example, the printer 40) to execute printing. Further, the printing server 20 is a device that is required in the practice of a printing management method according to an aspect of the invention, and briefly speaking, the printing server 20 manages printing and storage of sets of scan data. A term “server” used in this embodiment means not only a single server installed in its single housing, but also a set of a plurality of servers that are separately installed in their respective housings and that realize predetermined functions by cooperating with one another.

In the printing server 20, individual functions of functional components, that is, individual functions of a scanner communication portion 21, an image processing portion 22, an SS communication portion 23, a printer communication portion 24, and the like, are realized by allowing an installed program and a group of hardware components, such as a CPU, a ROM, a RAM, a storage device (a hard disc or the like), other memory devices, and communication ports, to cooperate with each other. The individual functions of the functional components will be described below.

The SS 30 functions as an online storage that stores data therein in a state in which the data is ready for being downloaded by external terminals. The printing server 20 and the SS 30 may be operated by an identical operating company, or may be operated by respective mutually different operating companies.

Hereinafter, for convenience of description, a user of the scanner 10 will be referred to as a first user, and a user of the printer 40 will be referred to as a second user. The first user and the second user may be an identical person, or may be mutually different persons having a relationship of some kind therebetween. Further, the concept of the user includes not only a person, but also a corporation and an organization. As an application example of this embodiment, it is assumed a case where the scanner 10 and the printer 40 exist at their respective locations that are physically far from each other (i.e., a case where the scanner 10 is installed at a first office and the printer 40 is installed at a second office).

As a premise of this embodiment, it is assumed that the second user already completes the registration of the printer 40 into the printing server 20 (refer to, for example, JP-A-2012-159914 when needed). Specifically, the registration of the printer 40 into the printing server 20 is a process of performing a user registration (i.e., a process of registering the printer 40) into an e-mail printing system operated by a certain printer manufacturer or the like. For example, the second user having purchased the printer 40 that is a product of a printer manufacturer A registers the purchased printer 40 into an e-mail printing system (the printing server 20) operated by the printer manufacturer A (or an operating company associated with the printer manufacturer A).

The second user transmits a request for a registration of the printer 40 by operating a terminal (not illustrated). Such a request for the registration is made through, for example, a graphical user interface (GUI) inside a Web pager that is provided by the printing server 20 via the Internet. The detailed description of such a registration of the printer 40 is omitted here, but, briefly speaking, pieces of information specific to the device body of the printer 40 (i.e., a device type ID, a serial number, and the like), as well as pieces of predetermined personal information related to the second user, are registered into the printing server 20; and, as a response to the registration, a printer mail address that is uniquely allocated to the registration target printer 40 is generated and notified to the second user by the printing server 20.

### 1.2 Storage and Printing of Scan Data

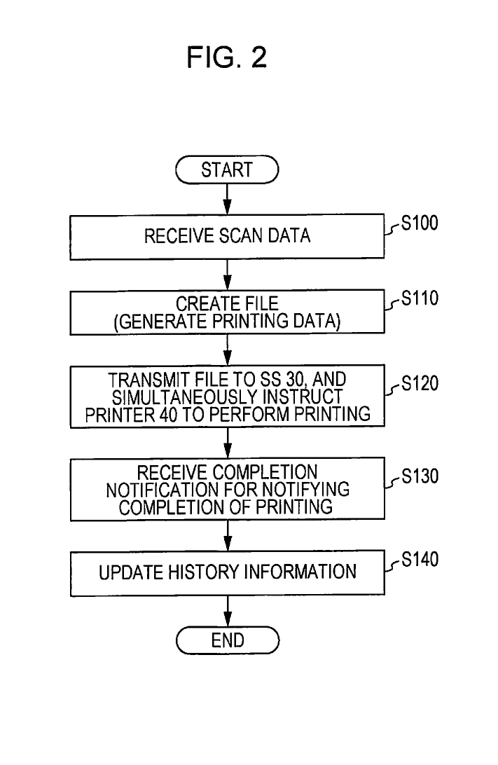

FIG. 2 is a flowchart illustrating processes performed by the printing server 20 in this embodiment.

In step S100, the scanner communication portion 21 receives a set of scan data from the scanner 10 via the Internet. In this meaning, the scanner communication portion 21 is also referred to as a scan data receiving portion. Further, the set of scan data received here is accompanied by a set of information that designates a storage destination and a printing destination of the set of scan data.

When the first user operates the scanner 10 to transmit a set of scan data from the scanner 10 to the printing server 20, the first user also operates the scanner 10, concurrently with the operation for transmitting the set of scan data, to designate a storage destination and a printing destination of the set of scanner data. The storage destination indicates a storage area that is associated with a specific user and that is secured in the SS 30 in advance. For example, it is assumed that the first user is a user who is already registered in the SS 30, and has a piece of unique information (an account) that is associated with the storage area. In addition, the above “account” collectively indicates, for example, a user ID, a password, and the like. Further, the printing destination indicates the printer 40 that is allocated as a printer that executes printing based on the set of scan data. The printer 40 as the printing destination is designated by using a printer mail address. That is, when the first user operate the scanner 10 to transmit a set of scan data from the scanner 10 to the printing server 20, the first user also operates the scanner 10, concurrently with the operation for transmitting the set of scan data, to designate an account that is associated with the storage area secured in the SS 30 as well as a printer mail address that is allocated to the printer 40, and transmit the designated account and printer mail address to the printing server 20 together with the set of scan data. Here, it is assumed that the first user knows the printer mail address allocated to the printer 40 beforehand.

The first user may designate the storage destination and the printing destination of the set of scan data by directly inputting the account and the printer mail address through an unillustrated operation panel (i.e., a means that includes a liquid crystal display, various buttons, and the like, and that provides a user with a user interface).

Alternatively, the first user may install, in advance, specific application software, which is provided by the printing server 20 via the Internet, into the scanner 10. Further, the first user may register, in advance, accounts as candidates for a storage destination of a set of scan data as well as printer mail addresses as candidates for a storage destination of the set of scan data, into each of the printer server 20 and the scanner 10 through a GUI provided by the application software. Thereafter, the first user is able to designate a storage destination and a printing destination of each set of scan data merely by operating the operation panel of the scanner 10 to select one of the already registered accounts and one of the already registered printer mail addresses.

In step S110, the image processing portion 22 creates an image file having a predetermined format on the basis of the set of scan data having been received in step S100. Here, as the predetermined format, for example, a file format suitable for the storage by the SS 30, such as a PDF, is preferable. Since the received set of scan data is a set of bit-map data including, for each pixel, RGB (red, green, and blue) grayscale values, the image processing potion 22 convers such a set of scan data into an image file having a format suitable for the storage. In addition, this image file is a file having a format resulting from converting the format of the set of scan data having been transmitted from the scanner 10, and thus, this image file may be also referred to as a set of scan data.

Moreover, when creating such an image file, the image processing portion 22 appends pieces of history information relating to printing by the printer 40 corresponding to the designated printing destination, to the image file. The pieces of history information relating to printing are pieces of information indicating a printer that is allocated as a printer that executes printing (or a printer that has executed printing); a date and time when printing is to be executed (or a date and time when printing has been executed); and the like. The image processing portion 22 appends a piece of information that directly or indirectly represents the printer 40 as a printing destination (this piece of information being, for example, a printer mail address, the name of the relevant printer, or the like) to the image file as one of the pieces of history information, on the basis the piece of information that has been received together with the set of scan data in step S100 and that designates the printing destination. Further, the image processing portion 22 appends a date and time when the process in step S110 has been executed, to the image file as one of the pieces of history information. These pieces of history information are handled as one of kinds of properties (custom properties) of the image file. In step S120, the SS communication portion 23 transmits the image file having been created in step S110 on the basis of the piece of information that has been received together with the set of scan data in step S100 and that designates the storage destination. For example, the SS communication portion 23 transmits the account, which is a piece of information that designates the storage destination, to the SS 30 together with the image file. Upon reception of the image file and the account, the SS 30 stores the received image file into a storage area that is associated with the received account and that exists inside a storage device 31 for use in storing the image file.

In this step S120, concurrently with the above-described process of transmitting the image file to the SS 30, the printer communication portion 24 transmits the image file having been created in step S110 to the printer 40 corresponding to the designated printing destination (that is, the printer communication portion 24 instructs the printer 40 to execute printing), on the basis of the piece of information that has been received together with the set of scan data in step S100 and that indicates the designated printing destination. That is, the printer communication portion 24 transmits the image file to the printer 40 corresponding to the printer mail address that is the piece of information designating the printing destination, and instructs the relevant printer 40 to execute printing.

For example, the printing server 20 transmits an e-mail, in which its destination is set to the printer mail address that is the piece of information designating the printing destination, and to which the image file is attached as an attached file. Upon reception of the e-mail whose destination is the printer mail address that is allocated to the printer 40 itself, the printer 40 performs printing based on the image file that is attached to the received e-mail.

Alternatively, the printer 40 inquires of the printing server 20 about the presence/absence of a to-be-printed image file at regular intervals (or at irregular intervals) under a situation where the printer 40 itself is in a power ON state. When the printing server 20 having received the inquiry detects the presence of a set of scan data (an image file) whose printing destination is designated to the printer 40 having made the inquiry, the printing server 20 notifies the printer 40 of the presence of the to-be-printed image file. In response to this notification, the printer 40 downloads the image file whose printing destination is designated to the printer 40 itself from the printing server 20, and executes printing based on the image file.

As a result, a copy of a document having been subjected to scanning by the scanner 10 is printed by the printer 40 that is located far from the scanner 10.

In addition, the set of scan data itself as well as the image file itself generated from the set of scan data does not have a format suitable for printing by the printer 40. Thus, a process of converting the set of scan data or the image file into a set of printing data having a format suitable for printing by the printer 40 is required. This set of printing data corresponds to, for example, a set of data that is represented by a so-called page description language (PDL) or a set of dot data in which it is determined, for each pixel, whether or not an ink droplet is to be formed. In this embodiment, the process of generating such a set of printing data may be performed by the printer 40 having received the image file or may be performed by the printing server 20.

In the case where the set of printing data is generated at the printing server 20 side, the image processing portion 22 generates the set of printing data on the basis of the set of scan data or the image file in step S110.

Further, in step S120, concurrently with the processing by the SS communication portion 23 for transmitting the image file to the SS 30, the printer communication portion 24 transmits the set of printing data having been generated in step S110 to the printer 40 corresponding to the designated printing destination (that is, the printer communication portion 24 instructs the printer 40 to execute printing), on the basis of the piece of information that designates the printing destination. In this meaning, the image processing portion 22 can be also referred to as a printing data generation portion that generates a set of printing data, in accordance with which printing is performed, on the basis of the received set of scan data. In addition, the image file is a set of information that can be a source of printing executed by the printer 40, and thus, in this embodiment, it is not excluded that the image file is also referred to as a set of printing data.

Upon completion of the printing based on the image file (or the set of printing data), the printer 40 transmits a notification for notifying the completion of the printing (i.e., a printing completion notification) to the printing server 20.

In the printing server 20, the printing communication portion 24 receives the printing completion notification from the printer 40 (step S130).

Upon reception of the printing completion notification, the SS communication portion 23 updates the pieces of history information that are appended to the image file (step S140). For example, the SS communication portion 23 further appends pieces of new history information indicating a date and time when the printing completion notification has been received, a flag indicating the completion of the printing, and the like, to the image file which has been created by the image processing portion 22 in step S110 and to which the pieces of history information having been appended in step S110 are appended.

Subsequently thereto, the SS communication portion 23 transmits such an image file, to which such pieces of updated history information are appended, to the SS 30 on the basis of the piece of information that has been received together with the set of scan data in step S100 and that designates the storage destination. Upon reception of the image file to which the pieces of updated history information are appended, the SS 30 overwrites the image file, which has been transmitted from the printing server 20 at the timing of step S120 and is currently stored in the SS 30 and to which the pieces of history information having been appended in step S110 are appended, with the image file to which the pieces of updated history information are appended.

In the printing server 20 according to this embodiment configured in such a way as described above, when the first user causes the scanner 10 to scan a document, nearly simultaneously with the storage of a set of scan data into the SS 30, a copy of the document is automatically printed by the printer 40 that is located far from the scanner 10, on the basis of the set of scan data. For this reason, the second user's desire to promptly obtain a copy of the document is satisfied and, as a result, the efficiency of a second user's work is increased.

Further, the SS 30 is an online storage that stores data therein in a state in which the data is ready for being downloaded by external terminals. Thus, a user (the first user, the second user, or a user other than the first and second users) who knows an account associated with a storage area that is included in the SS 30 and that is the designated storage destination of sets of scan data (image files) stored in the storage area is able to browse the contents of each of the stored sets of scan data (the stored image files) by logging in to an online storage service, which is provided by the SS 30 via the Internet, with the relevant account through a terminal operated by the user himself or herself. Further, when browsing the contents of a certain one of the stored sets of scan data (the stored image files), the user is able to confirm the aforementioned pieces of history information by referring to the properties of the relevant stored set of scan data (the relevant stored image file). Thus, the user is able to easily confirm, for example, by which printer and at what date and time printing based on a certain set of scan data resulting from scanning of a document by the scanner 10 has been executed, or whether or not printing based on a certain set of scan data resulting from scanning of a document by the scanner 10 is already completed.

### 2. Other Embodiments

The invention is not limited to the above first embodiment, but can be practiced as various embodiments within the scope not departing from the gist of the invention and, for example, embodiments such as described below can be employed. Moreover, any configuration resulting from appropriately combining the embodiments is also included within the disclosed scope of the invention. In the description of embodiments below, items common to those of the first embodiment will be appropriately omitted from description.

### 2.1 Second Embodiment

In step S110, the image processing portion (printing data generation portion) 22 may be configured to generate a set of printing data including a piece of access information that is provided in a form of an image and that is for use in an access through the Internet to an online storage service provided by the SS 30.

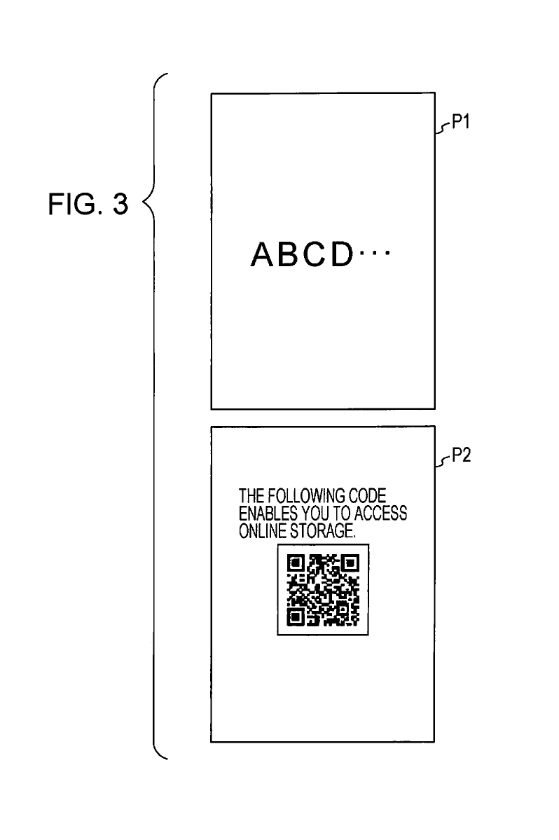

FIG. 3 is a simple diagram illustrating an example of images corresponding to a set of printing data that is generated by the image processing portion 22 on the basis of the set of scan data or the image file in this second embodiment. FIG. 3 illustrates two images each corresponding to a set of printing data associated with a corresponding one of two pages P1 and P2 each having a size of A4. As shown in FIG. 3, an image “ABCD . . . ” corresponding to a set of scan data resulting from scanning of a document is drawn on the page P1 and a two dimensional bar-code is drawn on the second page 2 as an example of various types of access information. In the two dimensional bar-code, for example, a piece of information indicating a uniform resource locator (URL) of a login screen for use in logging in to the online storage service provided by the SS 30 is embedded.

Through the transmission of such a set of printing data to the printer 40 in step S120, the second user is able to obtain not only a copy of a document having been subjected to scanning by the scanner 10 (as a result of printing of the page 1), but also a piece of access information (as a result of printing of the page 2). Further, the second user, who has obtained the result of the printing of the page P2, is able to utilize the online storage service provided by the SS 30 by causing a predetermined bar-code reader to read the two dimensional bar-code and accessing, via a terminal, the login screen for use in logging in to the online storage service provided by the SS 30.

The piece of access information in this second embodiment may be provided in a form other than the two dimensional bar-cord, and the URL itself (a character string) may be printed as the piece of access information. Further, it is possible to provide the second user with an easy-to-use printing result by generating a set of printing data that allows the image corresponding to the set of scan data and the image corresponding to the piece of access information to be each drawn on a corresponding one of mutually different pages, as shown in FIG. 3. In this regard, however, the image corresponding to the set of scan data and the image corresponding to the piece of access information are not necessarily to be each printed on a corresponding one of mutually different pages, but may be printed on the same page. In addition, the piece of access information is printed by the printer 40, but is not included in the image file stored in the SS 30 because the piece of access information is unlikely to be required by the image file stored in the SS 30.

### 2.2 Third Embodiment

The scanner 10 sometimes includes an auto document feeder or the like and performs continuous scanning of a plurality of documents by using the auto document feeder or the like. In such a case, a plurality of sets of scan data whose number corresponds to the number of the documents having been subjected to the continuous scanning are uploaded to the printing server 20 from the scanner 10. In view of this situation, the image processing portion 22 may be configured to, in step S110, create an image file (a set of edited scan data) in which the plurality of sets of scan data resulting from the continuous scanning of the plurality of documents are disposed within a common page.

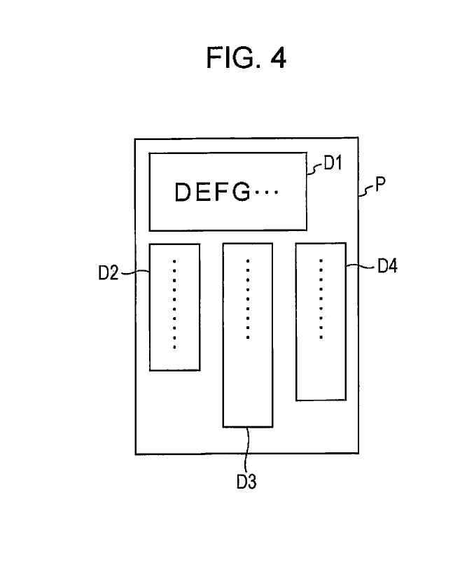

FIG. 4 illustrates an example of images corresponding to an image file that is created by the image processing portion 22 in this third embodiment. Specifically, FIG. 4 illustrates an example of images corresponding to an image file which is associated with one page (a page P) whose size is A4 and in which a plurality of sets of scan data D1, D2, D3, and D4 resulting from continuous scanning of a plurality of documents are disposed within the page P. When disposing the plurality of sets of scan data within a common page, the image processing portion 22 performs size reduction processing on any one or ones of the sets of scan data when needed in order to reduce the sizes of images each associated with a corresponding one of the any one or ones of the sets of scan data. In this regard, however, it is essential to avoid a situation where the contents of the size-reduced images are hard to be viewed in browsing of the image file and viewing of the result of printing by the printer 40. Thus, in order to keep comfort in viewing, in the image processing portion 22, a predetermined upper limit is provided in advance in a reduction ratio for use in the size reduction processing on the any one or ones of the sets of scan data. In the case where, when performing the size reduction processing employing a reduction ratio smaller than or equal to such an upper limit on any one or ones of a plurality of sets of scan data resulting from scanning of a plurality of documents, the sizes of images each associated with the any one or ones of the sets of scan data are reduced and, as a result, all images associated with the plurality of sets of scan data can be contained within one page, the image processing portion 22 creates an image file in which the plurality of sets of scan data are disposed within a common page.

According to this third embodiment configured in such a way as described above, the SS communication portion 23 transmits such an image file in which a plurality of sets of scan data are disposed within a common page to the SS 30; and the printer communication portion 24 transmits the image file in which the plurality of sets of scan data are disposed in a common page to the printer 40 (step S120). Alternatively, the image processing portion (printing data generation portion) 22 generates a set of printing data from such an image file in which a plurality of sets of scan data are disposed within a common page (step S110); and the printer communication portion 24 transmits the relevant set of printing data to the printer 40 (step S120). Thus, this method enables the second user to obtain the copies of the plurality of documents having been subjected to scanning by the scanner 10 by using paper sheets whose number is smaller than the number of the documents, and thus, this method is superior in view of cost savings. Moreover, when a user accesses the SS 30 to browse sets of scan data stored in the SS 30, the user is able to efficiently browse the sets of scan data because a plurality of sets of scan data each associated with a corresponding one of a plurality of documents are collectively disposed within the same page.

The entire disclosure of Japanese Patent Application No. 2014-236453, filed Nov. 21, 2014 is expressly incorporated by reference herein.

What is claimed is:

1. A printing server comprising:
a scan data receiving portion that receives, via the Internet, a set of scan data resulting from scanning of a document;
a storage server communication portion that transmits the set of scan data to a storage server that stores data therein in a state in which the data is ready for being downloaded by an external terminal;
a printing data generation portion that, on the basis of the set of scan data, generates a set of printing data in accordance with which a printer performs printing; and
a printer communication portion that transmits the set of printing data to a printer corresponding to a designated e-mail address.

2. The printing server according to claim 1, wherein the storage server communication portion appends a piece of history information relating to printing by the printer corresponding to the designated e-mail address, and transmits the set of scan data, to which the piece of history information is appended, to the storage server.

3. The printing server according to claim 2, wherein the printer communication portion receives a completion notification for notifying a completion of the printing in accordance with the set of printing data, from the printer corresponding to the designated e-mail address, and upon reception of the completion notification, the storage server communication portion appends a piece of information relating to the completion of the printing to the set of scan data as the piece of history information.

4. The printing server according to claim 1, wherein the printing data generation portion generates the set of printing data such that the set of printing data includes a piece of access information that is provided in a form of an image and that is for use in an access through the Internet to a service provided by the storage server.

5. The printing server according to claim 4, wherein the printing data generation portion generates the set of printing data such that an image corresponding to the set of scan data and an image corresponding to the piece of access information are each drawn within a corresponding one of mutually different pages.

6. The printing server according to claim 1, further comprising an image processing portion that generates a set of edited scan data corresponding to a plurality of sets of scan data each of which results from scanning of a corresponding one of a plurality of documents and which are disposed within a common page,
wherein the storage server communication portion transmits the set of edited scan data to the storage server, and the printing data generation portion generates the set of printing data on the basis of the set of edited scan data.

7. A printing management method comprising:
a scan data receiving process of receiving, via the Internet, a set of scan data resulting from scanning of a document;
a storage server communication process of transmitting the set of scan data to a storage server that stores data therein in a state in which the data is ready for being downloaded by an external terminal;
a printing data generation process of, on the basis of the set of scan data, generating a set of printing data in accordance with which a printer performs printing; and
a printer communication process of transmitting the set of printing data to a printer corresponding to a designated e-mail address.

8. A data storage printing system comprising:
a printing server that transmits a set of printing data to a printer corresponding to a designated e-mail address to cause the printer to perform printing in accordance with the set of printing data; and
a storage server that stores data therein in a state in which the data is ready for being downloaded by an external terminal,
wherein the printing server includes a scan data receiving portion that receives, via the Internet, a set of scan data resulting from scanning of a document, a storage server communication portion that transmits the set of scan data to the storage server, a printing data generation portion that, on the basis of the set of scan data, generates the set of printing data in accordance with which the printer corresponding to the designated e-mail address is caused to perform printing, and a printer communication portion that transmits the set of printing data to the printer corresponding to the designated e-mail address.
